(19) United States
(12) Patent Application Publication
(10) Pub. No.: US 2015/0019343 A1
(43) Pub. Date: Jan. 15, 2015

(54) Method and System for Student Information Data Collection and Student Marketing Material Generation

(71) Applicant: Rezolve Group, Inc., Sacramento, CA (US)

(72) Inventors: Craig V. Carroll, Woollahra (AU); Matthew Payden Phillips, Rancho Cordova, CA (US)

(21) Appl. No.: 14/326,984

(22) Filed: Jul. 9, 2014

Related U.S. Application Data
(60) Provisional application No. 61/844,484, filed on Jul. 10, 2013.

(51) Int. Cl. G06Q 30/02; G06Q 50/20

(52) U.S. Cl. CPC G06Q 30/0269; G06Q 50/20
USPC 705/14.66

(57) ABSTRACT

A method and system for generating targeted marketing materials or presentations (e.g., marketing packets) is disclosed. The system utilizes a series of surveys used to identify areas of interests (e.g., academic, sports, location), concerns (e.g., student loans, making friends, paying for school), and also acquire background information of the potential students. This acquired information is then used to generate targeted marketing presentations such as packets that address each student's particular interests and concerns.

### RELATED APPLICATIONS

This application claims the benefit under 35 USC 119(e) of U.S. Provisional Application No. 61/844,484, filed on Jul. 10, 2013, which is incorporated herein by reference in its entirety.

### BACKGROUND OF THE INVENTION

Many academic institutions provide admission, enrollment, and cost information to potential students and/or applicants via their websites or by way of standardized prospectuses or brochures that profile and overview information about the academic institutions. This is especially true for post-secondary institutions. The academic institutions will also often provide more detailed cost information, such as published tuition costs, room and board costs, and miscellaneous costs, such as books and laboratory fees, which typical students might be required to pay as a consequence of their attendance at the academic institution. Likewise, academic institutions will often provide general (non-student specific) information about how to apply for financial aid programs such as scholarships, loans, work-study programs, and grants that students might access while attending the academic institution.

The academic institutions also provide net price calculators (or NPCs) to potential students. These calculators give the potential students personalized net price estimates. They often take into account the students' unique circumstances (e.g., personal savings or family contributions), the institution's unique financial aid offerings, as well as the students' eligibility for federal, state and/or military student aid.

More recently, systems have been proposed that enable the mass customization and personalization of marketing documents for potential students. These systems leverage existing systems to provide students with net price information on the total cost of attending an academic institution and supplement this financial information with marketing information that is customized and created for the potential students based on the financial information that the potential student provided along with any other information such as desired degree type (e.g., associates or bachelors degree), program of study and/or major (nursing, engineering, English literature), extracurricular activities (clubs, student government), student life issues (on and off campus housing, dining options), and sports programs and teams (football, soccer), to list a few examples.

At the same time, new systems are being developed that provide lightweight methods of assessing customer personality. For example, U.S. Pat. Appl. Pub. No. 2013/0060604 A1 is directed to a system for consumer matching that uses a visual affinity test. The customer is polled by choosing between “me” or “not me” in response to a series of images that are shown to the consumer who may be seeking a certain experience (e.g. service, event, experiential activity). These images have been assigned certain ranked personality traits according to the matching service's perception of the psychological content of the images. These responses to the tagged images are used to formulate the consumer's personality trait profile. These are then matched against a database of experiences that have been ascribed similar tags/personality traits and that are available from those businesses (e.g., providers of a wide range of services, events, and experiential activities) which have registered with the database. The result of this matching is the compiling for the consumer of a list of ranked businesses. The ranking addresses the experience being sought by the consumer and those businesses that are most optimally matched to the compatibility of the consumer's personality trait profile.

### SUMMARY OF THE INVENTION

Academic institutions compete for potential students with certain desired attributes. While enrolling a sufficient volume of students is an important objective, many academic institutions are more concerned with seeking out the best potential candidates (e.g., applicants) in terms of academic performance, success after graduation, and/or other attributes. These metrics are critical for an institution seeking to improve or maintain its ranking relative to other institutions and/or build an alumni/alumnae network.

At the same time, students can be unsophisticated in their awareness of the distinctive attributes or value propositions of each particular academic institution. Thus, it is important for those academic institutions, when marketing to students, to emphasize the appropriate services, academic opportunities, and social opportunities to each particular student that correspond to the value propositions that each student is seeking.

Recently, many academic institutions have started realizing that it is generally not possible to promote a “one-size-fits-all” experience for all potential students and still recruit the best candidates. This is because each potential student desires different services, academic opportunities, and social opportunities. Likewise, potential students typically have different motivations for attending the institutions. For example, some potential students view college as a stepping stone for advancing toward a specific career, while other students view college as an opportunity for new experiences and to find what career path they want to pursue. Similarly, some potential students aim to advance their career via advanced degrees, while other students hope to obtain degrees in order to switch careers. Thus, it is beneficial for the academic institutions, when generating marketing material for potential students, to generate marketing content or presentations, packets, or online or electronic multimedia experiences that include images, documents, and/or video that are crafted to highlight the aspects of the academic institution that will be most interesting to each particular student while also addressing concerns that the student may have. Likewise, it is beneficial for academic institutions to both: understand the uniqueness of each student and what each potential student needs/wants in terms of an academic experience; as well as communicate with each potential student in a custom, rather than mass (e.g., “one-size-fits-all”), manner.

The present invention is directed to a method and system for student information collection and student marketing material generation. The system uses a series of surveys to identify the potential students' interests, concerns, and also acquire other background information on the potential students. This information, known as the student's interest profile, is then used to generate personalized, targeted marketing material or presentations (e.g., marketing packets and documents or online or electronic experiences) that addresses those students' particular interests and concerns.

In one example, a personalized marketing presentation (e.g., marketing packet) is generated for each potential student/candidate. This presentation takes advantage of experience mapping, which is mapping a set of experiences that the institution offers to the spectrum of personal preferences of the different potential students. This approach enables the academic institution to engage potential students at an extremely personal, emotional level. This approach has the ability to present a totally different college experience to two different potential students and thus communicate a unique college experience that is tailored to each potential student. Moreover, the experience mapping is able to incorporate value proposition messaging that “sell” the value of the institution while the potential student continues to share information about their likes, dislikes, and concerns.

In another example, the system for student information collection is made available to potential students who have yet to indicate interest in any particular academic institution. A series of surveys presents imagery that leads to the identification of the student's interests, concerns, and/or passions that are independent of any particular academic institution. For example, a potential student may indicate they are interested in a degree in business, but this is indicated as a generic interest in this area of learning and not specific to a single academic institution or its offered programs. In this example, a personalized marketing presentation (e.g., marketing packet) is created for many schools that meet the potential student's interest profile or the student may be provided with a summary of their interest profile to aid them in the selection of an academic institution that provides offerings that align with their desired educational experience.

In general, according to one aspect, the invention features a computerized method for generating a personalized presentation for marketing an academic institution or multiple institutions to a potential student. The method comprises generating a user interface on a user device that enables a potential student to express personal preferences and/or personal information by selecting images displayed on the user device. The computer system then determines personalized marketing content that is relevant to the potential student based on the selected images and the student's ranking of the images and the computer system generates marketing content (e.g., a document) customized to the potential student that includes the personalized marketing content.

In various embodiments, the presentation is transferred to a letter shop to be printed and mailed to the potential student, presented to the potential student as an online or electronic, such as multimedia, experience or via a presentation downloader, and/or emailed to the email address of the potential student.

In embodiments, the presentation is customized to the potential student using the personal preferences expressed by the potential student to select marketing content, such as images and written material, that is relevant to the potential student that is stored in a database and then accessed and incorporated into a single document.

Typically, the potential student expresses personal preferences by selecting between two or more images displayed on the user device and/or by ranking images displayed on the user device. Alternatively, personal information can be provided by indicating a personal preference (e.g., a positive or negative response) to a single image displayed on the user device. Personal information can also be provided by enabling the potential student to select between or ranking multiple (such as 3 or 4) images displayed on the user device.

In general, according to another aspect, the invention features a computer system for generating a personalized presentation for marketing an academic institution to a potential student. This computer system generates a user interface on a user device that enables a potential student to express personal preferences and/or personal information by selecting images displayed on the user device, determines personalized marketing content that is relevant to the potential student based on the selected images, and generates a presentation customized to the potential student that includes the personalized marketing content.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating an overview of the relationship between potential students, the academic institution's website, a net price calculator, and an affinity assessment app/Web server;

FIG. 2 is a block diagram illustrating how the affinity assessment server first interrogates the students to find their interests and then uses that information to generate targeted marketing materials;

FIGS. 3A-3B are screenshots of a graphical user interface displayed on a user device, the screenshots showing a general interest survey that uses the “Like” and “Dislike” paradigm;

FIGS. 4A-4C are screenshots from the user device of a customized interest survey;

FIGS. 5A-5C are screenshots of a details survey from the user device;

FIG. 6A-6F shows an exemplary marketing report mailer; and

FIG. 7 is a flow diagram showing more detailed steps associated with the standard interest survey and the customized interest survey shown in FIG. 2.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

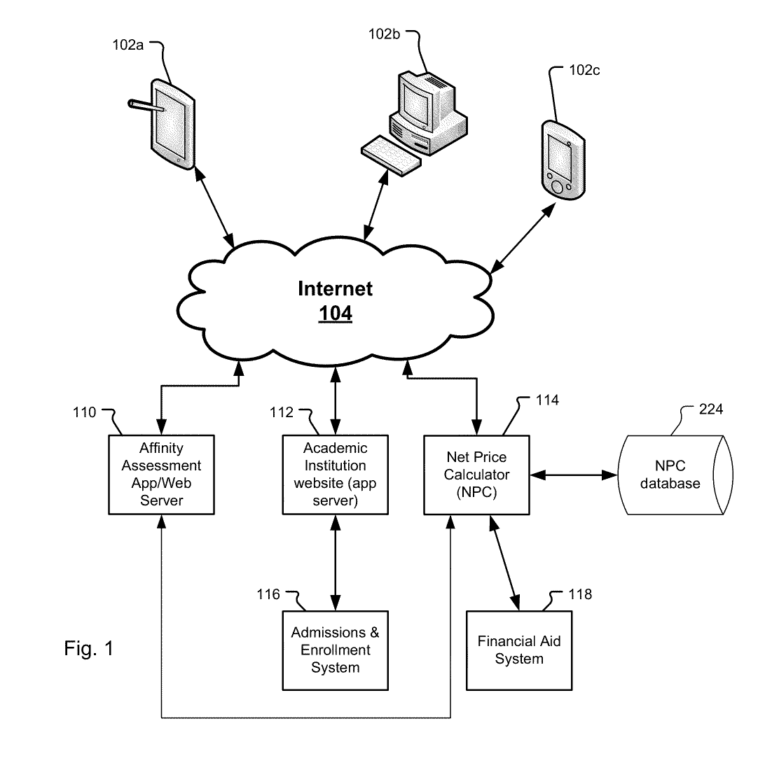

FIG. 1 illustrates an overview of the relationship between user devices 102a-c operated by potential students, an academic institution's website 112, the computer system 114 (i.e., net price calculator) for calculating net price of attending an academic institution, and an affinity assessment application (app)/Web server 110.

Also shown in FIG. 1 is the integration with institutional computer/student aid information systems (e.g., admissions and enrollment computer system 116) and a financial aid and/or bursar's computer system 118.

In a typical implementation, the potential students (or candidates) operate user devices 102a-c such as personal computers, laptops, tablet devices, or smart phones to access the academic institution's website 112 via a computer network such as the Internet 104 and display information via display devices. In a preferred embodiment, the potential students use Internet (HTML (Hypertext Markup Language)) browsers or application programs (apps) to navigate to a website either hosted by the academic institution or by a third party. In an alternative embodiment, the potential students may access the academic institution's website 112 from a computer terminal or kiosk located on the academic institution's campus.

In one implementation, the academic institution's website 112 directs interested, potential students to the interests or affinity assessment app/Web server 110, which includes a utility executing on the affinity assessment app/Web server 110. Here, a graphical user interface is presented on the user devices 102a-c preferably as a series of pages sent to the browser running on the user devices 102a-c or pages/data sent to an application (app) running on the user devices 102a-c. The pages guide the potential students through a series of screens that display information, directions, and questions that are part of a series of surveys that are completed by the potential students to understand their individual interests or affinities or concerns. The data from the surveys enable the affinity assessment app/Web server 110 to generate personalized marketing packets for the potential students based in their determined interests.

In an alternative embodiment, the affinity assessment app/Web server 110 is available to potential students who have yet to indicate interest in any particular academic institution. In this embodiment, the affinity assessment app/Web server 110 presents imagery (e.g., surveys) that identify the student's interests, concerns, and passions that are independent of any particular academic institution. Illustrated by way of example, a potential student may indicate they are interested in a degree in business, but this interest is indicated as a generic interest in this field and not specific to a particular academic institution or its offered programs. In this example, a personalized marketing document may be created for multiple schools that meet the potential student's interest profile. Alternatively, a personalized marketing document may be generated providing a summary of the potential student's interest profile to aid them in the selection of an academic institution that provides offerings that align with their desired educational experience.

The potential students are also encouraged to utilize the net price calculator (NPC) 114 in some implementations. This is a utility that calculates the cost and net price of attendance to a specified academic institution. Additionally, the information entered by the potential students in the NPC 114 is stored in the NPC database 224 and transferred to the affinity assessment app/Web server 110 and financial aid system 118, in one example.

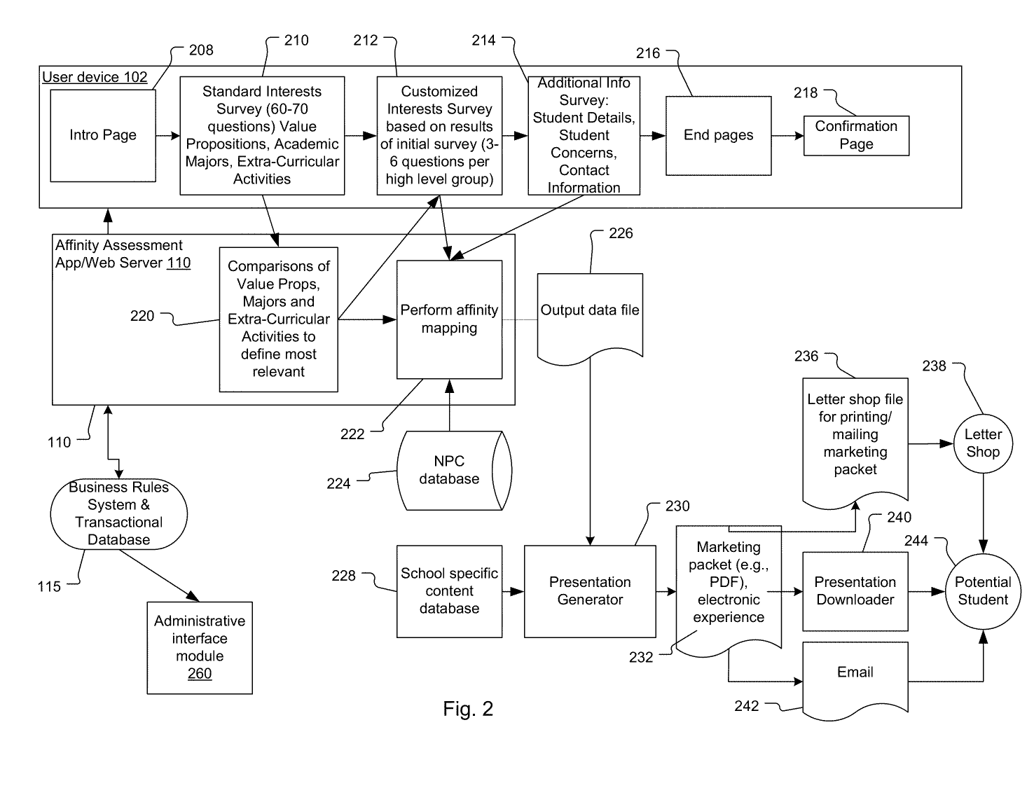

FIG. 2 is a block diagram illustrating the operation of the affinity assessment app/Web server 110 and the surveys that are provided to the user devices 102 of the potential students and the subsequent generation of the marketing packets that are personalized for each of those students.

In more detail, a business rules system and transactional database 115 stores custom information that is displayed in the surveys. This custom information includes custom paragraphs (e.g., information, directions, and questions), custom photos/images, custom backgrounds, academic institution information, school contact information, and a template or other layout information, to list a few examples. Additionally, the business rules system and transactional database 115 also preferably include a set of logical steps that guide the direction of the affinity assessment app/Web server 110 during the presentation of the surveys. In one specific example, the logical steps are part of a decision making tree, which may be patterned after an analytical hierarchical process (AHP) of decision making.

The custom information and logical steps enable the affinity assessment app/Web server 110 to generate individualized surveys for each potential student that are tailored to each potential student's academic goals and personal interests. In some examples, this preliminary targeting of the surveys is enabled by information that the students previously entered via the net price calculator 114.

In any event, the surveys enable the potential students to express personal preferences by selecting between one or more images displayed on the user devices.

The business rules system and transactional database 115 also interfaces with an administrative interface module 260. This administrative interface module 260 generates reports that provide information on the usage of the affinity assessment app/Web server 110. The reports detail the number of candidates that have accessed the survey and the number of candidates that have fully completed survey, for example.

In more detail, these reports cover the usage of the affinity assessment app/Web server 110 as well as any trends that are emerging through the potential students' responses to the surveys presented by the affinity assessment app/Web server 110. In terms of usage, the reports provide, for example: total users (e.g., potential students) starting the surveys, total users completing the surveys, total users providing contact information (e.g., email, phone, address), breakdown of usage by gender, ethnicity, traditional student vs. adult student, state, age, intended start date, potential student trends including what are the top ranking academic areas of interest within each high level academic area of interest, what are the top ranking academic major categories, what are the most important college value propositions to potential students, what are the most popular extracurricular activities for potential students, what are the largest concerns among potential students, and what are the most recommended clubs, organizations, and groups based on student responses.

The administrative interface module 260 also enables the retrieval of information for specific candidates. It enables the searching of the data collected based on a candidate's name or other unique field that is provided in the contact information area.

Each student record typically includes contact information the potential student provided as well as an outline of the data they provided. The data for each potential student include: a list of which academic areas of interest the potential student said “Like” (or “Me”) to and which were the highest ranked, a ranked list of the sub-members in the potential student's highest ranked academic area of interest to indicate what specific major type they are interested in, a list of the college value propositions that the potential student said “Like” (or “Me”) to and which were the highest ranked, a list of the extracurricular activities that the user said “Like” (or “Me”) to and/or which were the highest ranked, a list of the specific clubs, activities or organizations that were recommended to the potential student based on their answers, a list of the potential student's responses to the college experience preference questions (housing, size of college, and college lifestyle), indication of the potential student's largest concern. This information can be used to facilitate a more meaningful and personalized conversation with the potential student.

For example, if a potential student is interested in engineering, then the surveys generated by the affinity assessment app/Web server 110 include custom photos, paragraphs, backgrounds, and templates related to science and engineering.

The affinity assessment app/Web server 110 then provides a series of pages to the user device 102. In one example, these pages are simply provided to an Internet browser executing on the user device 102. In other examples, the pages are provided through an app that is installed on the user device 102.

Typically, the pages that are displayed on the user device start with an introduction page 208. This introduction page 208 allows the potential student to invoke a standard interest survey 210, which is designed to better understand the students' interests. In the current embodiment, the standard interest survey 210 is provided to the potential student via their user device 102. In one case, the standard interest survey 210 includes about 60 to 70 questions. The questions seek to better understand the student's values, potential academic majors, and interest in extracurricular activities, to list a few examples.

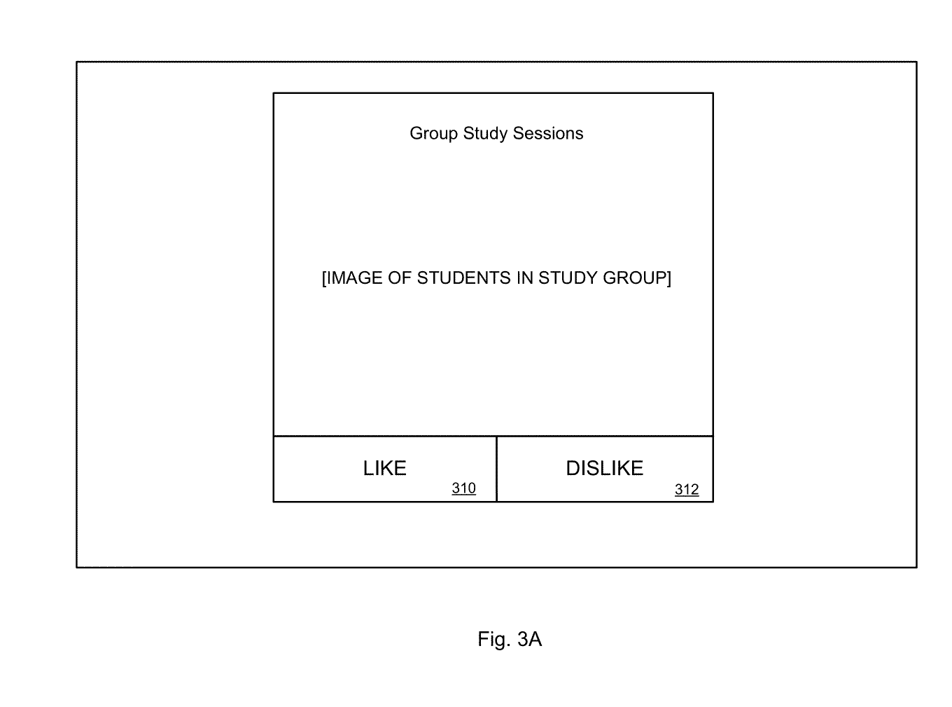

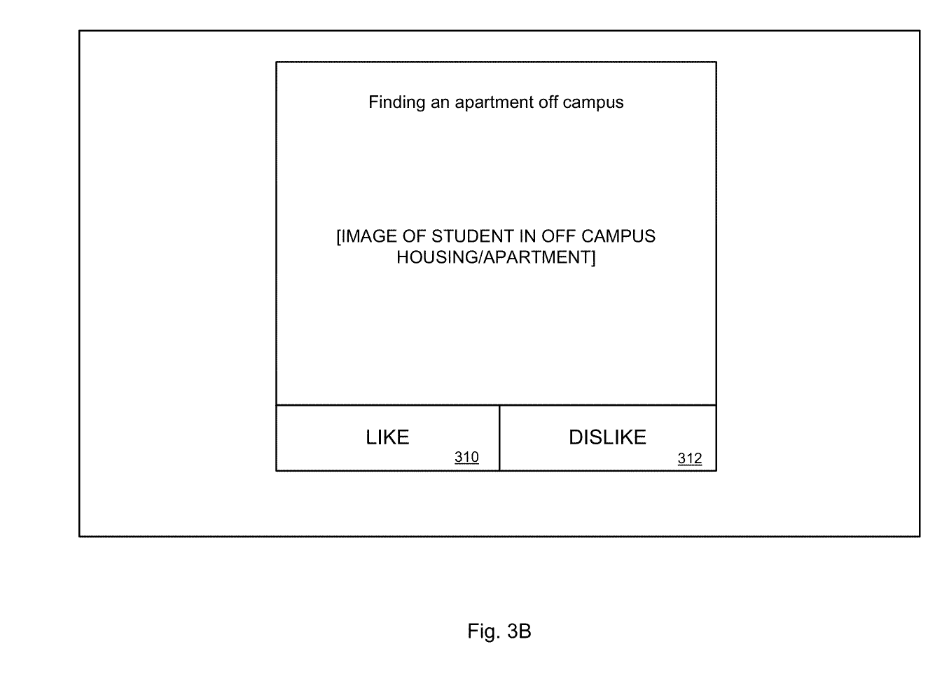

FIGS. 3A and 3B illustrate examples of the questions presented in the standard interest survey 210 according to one embodiment that is displayed as part of the user interface on the user device(s) 102. Specifically, a series of images are shown to the potential student and then the potential student simply selects “Like” active area 310 or “Dislike” active area 312 on the screen or display of the user device 102. By this selection, the potential student expresses personal preferences on various matters that relate to their selection of an academic institution.

In the illustrated examples, exemplary questions include whether or not the potential student considers study sessions to be consistent with their individual interests (i.e., the question illustrated in FIG. 3A) or whether or not they might find it a drawback to have to search for an apartment or off-campus housing (i.e., the question illustrated in FIG. 3B).

In the illustrated examples, the questions are presented as a single image to which the potential students choose “Like” or “Dislike.” Alternatively, the images could be presented with dichotomous choices such as “Me” and “Not Me”, “Yes” and “No”, or “Prefer” and “Oppose”, to list a few examples. In an alternative embodiment, two or more images are presented and the potential student selects which of the images is most preferred. In yet another alternative embodiment, the potential student is presented with three or four (or more) images and ranks the images in order of preference or selects a top choice. In still another embodiment, only a single image is displayed and the potential student indicates an affinity for the activity illustrated by the image.

Returning to FIG. 2, the affinity assessment app/Web server 110 then receives the feedback and answers to the questions from the standard interest survey 210. Next, the affinity assessment app/Web server 110 compares the student input information from the standard interest survey 210 to the value propositions, majors, and extracurricular activities that are offered by the academic institution (e.g., university) in step 220. This is to determine the most relevant areas of interest.

The collected information from the standard interest survey 210 is then used to generate a customized interest survey 212. The nature of this customized survey 212 is based on the results of the standard interest survey 210. In one example, it includes 3 to 6 questions for each high level group or area of interest that the potential student may have selected in the standard interest survey 110.

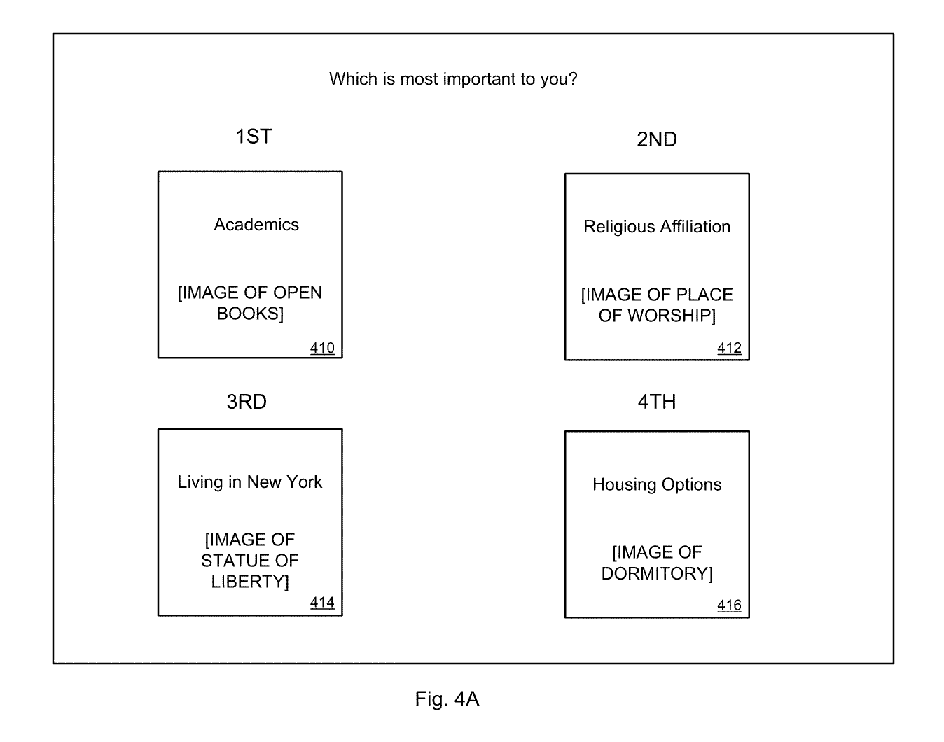

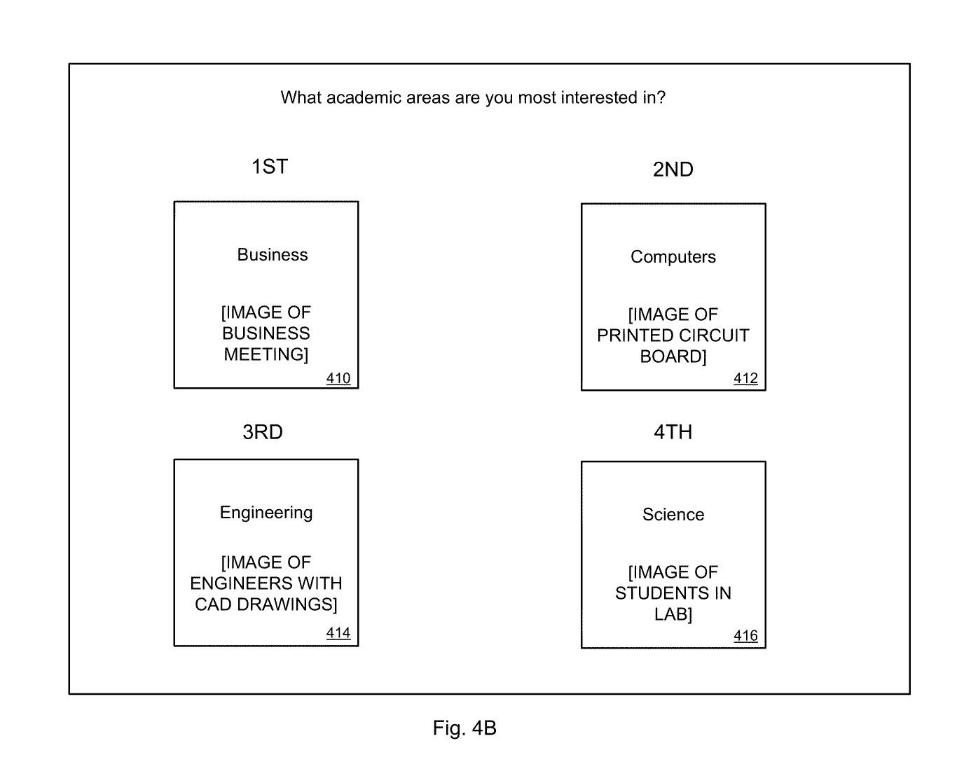

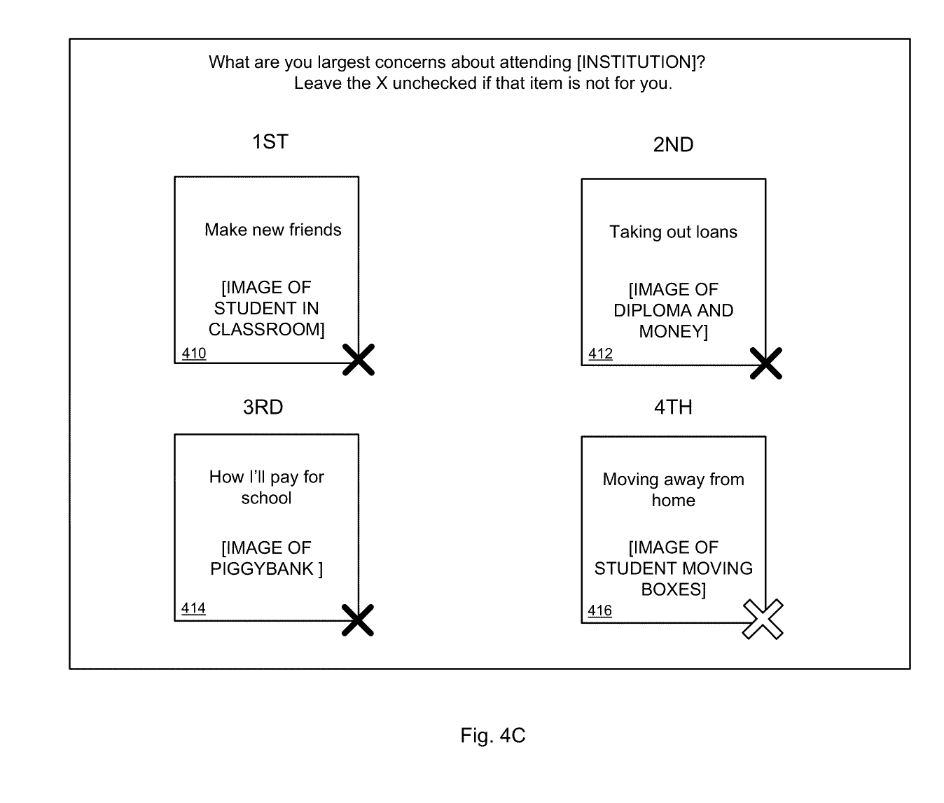

FIGS. 4A through 4C illustrate examples of the questions presented by the customized interest survey 212 that are displayed as part of the user interface on the user device(s) 102. In this example, more than a binary response is requested from the potential students. Here again, the potential student is expressing personal preferences on various matters that relate to their selection of an academic institution by selecting among images displayed on their potential student device.

For example, as illustrated in FIG. 4A, the potential student is asked which is most important in the potential student's decision whether or not to attend that academic institution: academics, religious affiliation, the city in which the university is located, or the housing options offered by the academic institution. The potential student makes a selection by picking one of the active areas 410, 412, 414, or 416 associated with different images. In an alternative embodiment, the potential student is asked to rank among these four areas indicating the order in which the potential student feels these are most important.

In FIG. 4B, the potential student is asked which academic interests are most important to the student among business, computers, engineering, and science, for example. It should be noted, that the particular areas of interests that the potential student is requested to select among are based upon the prior information that has already been obtained by the student. Typically, these particular interests that the student is requested to select among was based on information that was gained from the standard interest survey 210. In another example, the student information was further obtained from information entered into the net price calculator 114.

In FIG. 4C, for example, the potential student is asked to indicate the largest concerns the potential student may have when attending the academic institution. Examples of concerns include making new friends, taking-out student loans, paying for school, or moving away from home. In the illustrated example, the potential student is permitted to select multiple concerns. In an alternative embodiment, the potential student is asked to rank these areas in the order in which the potential student feels these are most concerning.

Returning to FIG. 2, in one embodiment, additional potential student information is obtained via an additional information survey 214. This additional information can be student details, additional student concerns, contact information, and/or other information from the student such as ethnic background or disability information, to list a few examples.

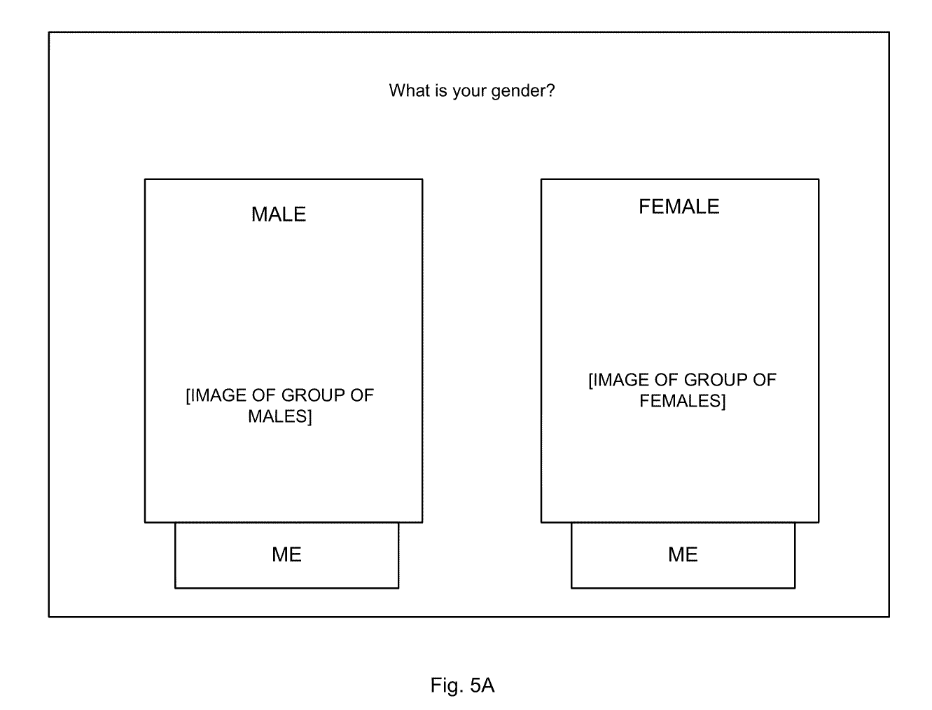

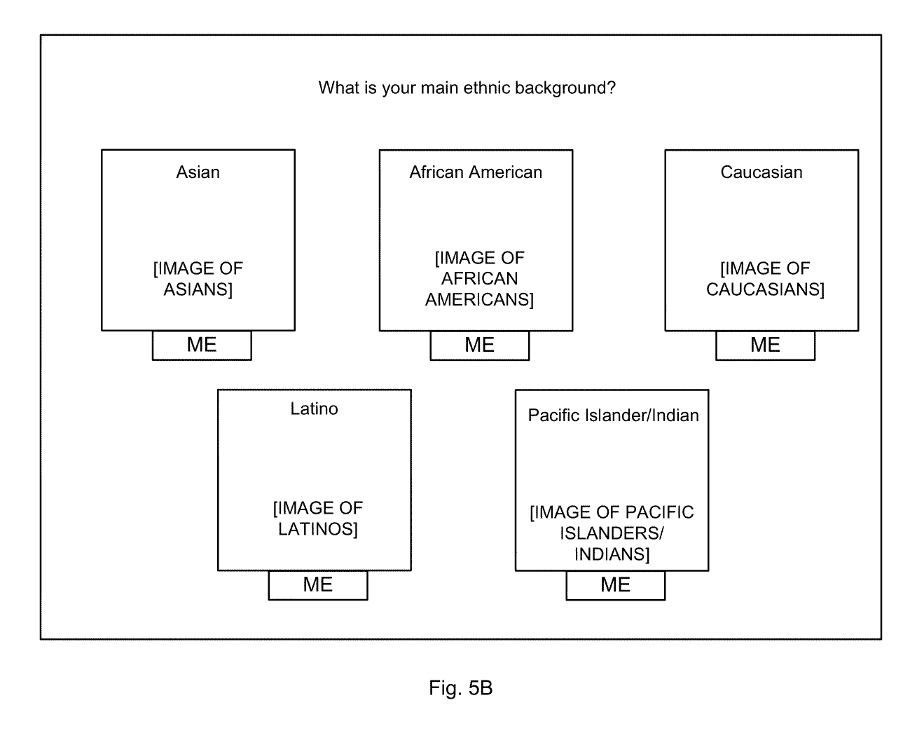

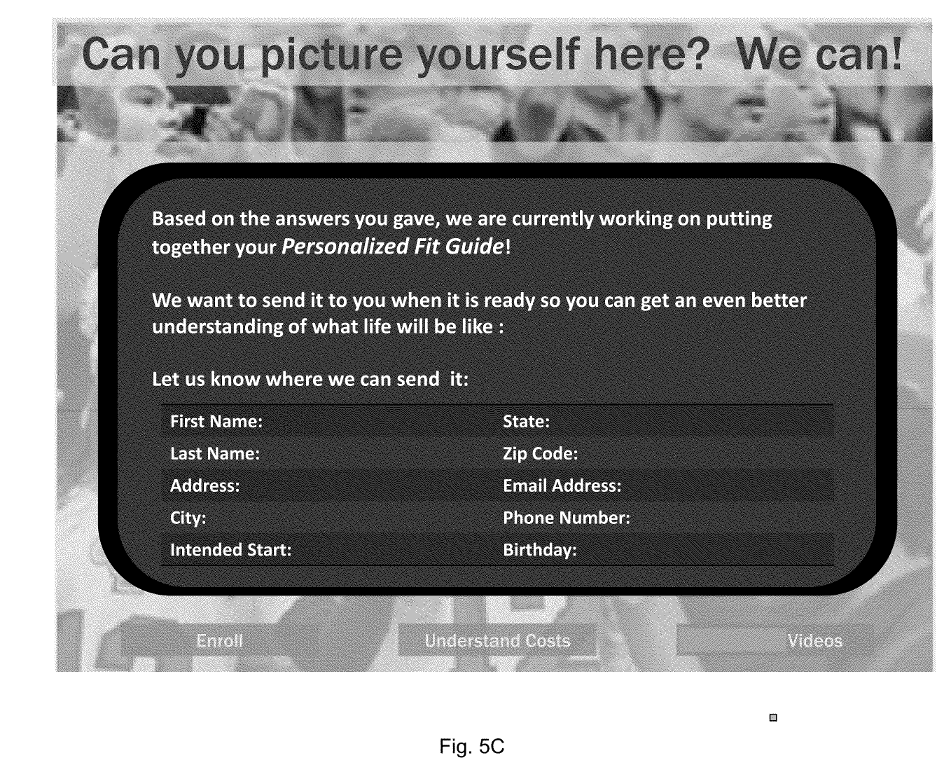

FIGS. 5A through 5C illustrate some of the pages that are provided by the affinity assessment app/Web server 110 on the user device 102 for the additional information survey 214. In the illustrated examples, the potential student provides personal information by selecting among images displayed on their user device.

For example, FIG. 5A shows a question that asks the gender of the potential student. The potential student simply indicates their choice by selecting one of the active areas (i.e., “Me” buttons) FIG. 5B shows a question that asks the main ethnic background of the potential student. Again, the potential student simply indicates their choice by selecting one of the active areas (i.e., “Me” buttons). In some embodiments, the potential student is able to select more than one ethnic background. Additionally, in some embodiments, potential students are permitted certain skip questions that they do not wish to answer.

FIG. 5C illustrates a page that enables the potential student to enter their contact information (e.g., name, mailing address, email address, phone number), intended start date, and birthday. In some examples, this additional information is not required because it is provided in the NPC database 224 that was generated by the net price calculator 114.

Returning to FIG. 2, in one embodiment, end page 216 and a confirmation page 218 are provided to the potential student upon completing the surveys 210, 212, 214. Here, the potential student receives an immediate output that summarizes their answers and gives them some insight into how the academic institution is a good fit for them. The confirmation page 218 provides selectable options to receive more information via direct mail as well as additional next steps presented that will advance the candidate forward in the process of enrolling at the academic institution.

After receiving the information from the surveys 210, 212, 214, the affinity assessment app/Web server 110 performs affinity mapping 222 and compiles the potential student's transactional data as an output data file 226. The transactional data includes the results of the surveys 210, 212 along with academic, financial, and personal information stored in the NPC database 224 collected during the use of the NPC 114 and/or additional information survey 214.

The information in the output data file 226 is then merged with content from a school specific content database 228 by a presentation generator 230. The presentation generator 230 seamlessly combines the collected information (e.g., financial and personal information) of the potential student from the output data file 226 with relevant content such as pictures from the school specific content database 228. The content selected from the school specific content database 228 is based on the results of the surveys 210, 212, 214. In some examples, the content includes written materials such as how to apply for on-campus housing which is provided to students that express housing concerns in the survey. Additionally, images of the school's dormitories are selected from the school specific content database 228. On the other hand, for potential students that expressed interests in clubs, lists of the school's clubs are accessed from the school specific content database 228 along with images from the database of the various clubs, in which the student is interested. Additionally, other information such as the date the presentation was created is also included. The result is a customized marketing presentation 232 that is specifically tailored to the interests of the potential student based on the results of the surveys 210, 212, 214. Thus, the potential students receive individualized information that is relevant to their interests in the academic institution such as whether they are interested are engineering, poetry, music, or chemistry. Likewise, the academic institution is able to better recruit students because the information being sent to each potential student 244 is personalized to the potential student's interests and concerns such as the availability of off-campus housing or the different study groups that are available to the student, to list a few examples.

In a typical implementation, the presentation generator 230 converts the marketing packet 232 into portable document format (or PDF) or other generic format. Once in portable format, presentation, such as the marketing packet PDF and/or electronic multimedia experience 232, is ready to be delivered to the potential student 244. Alternatively, or in addition, the information contained in the presentation, such as marketing packet 232, is presented as an immediate output (e.g., an online or electronic experience or a webpage), as personalized marketing content as well as other media for delivering this marketing packet.

In one embodiment, the marketing packet 232 is converted to a letter shop file 236 for printing and mailing via a letter or print shop 238 and sent through the postal system. Typically, the academic institution sends hundreds or thousands of customized marketing packets 232 as a portable document format file to the letter shop 238. The letter or print shop 238 is then able to print and mail the documents to the potential student 244 on behalf of the academic institution. Generally, the letter or print shop 238 is a third-party service provider such as a commercial print shop. Alternatively, the letter or print shop 238 is part of a department within the academic institution.

In an alternative embodiment, the marketing packet PDF 232 and/or electronic multimedia experience is made available to the presentation downloader 240 on a webpage hosted by academic institution or through a net price calculator interface. In one embodiment, the marketing packet or electronic experience 232 is made available on the confirmation page or on an additional page that is served to the potential student after they have finished the surveys. The presentation downloader 240 enables the potential student to access their marketing packet (or the online or electronic experience) immediately after it is generated.

In yet another embodiment, the document or series of web pages are displayed on the user devices of the potential students.

In another alternative embodiment, an email is sent to the potential student's email address with a hyperlink (or link) that directs to potential student to the document downloader page. In yet another alternative embodiment, the marketing packet 232 is attached and sent via email 242 to the potential student's email address that was provided by the student during the survey. In one example, the potential student selects this method of delivery via the confirmation page or through an option presented on an additional page that is served to the potential student after they have finished the surveys 210, 212, 214.

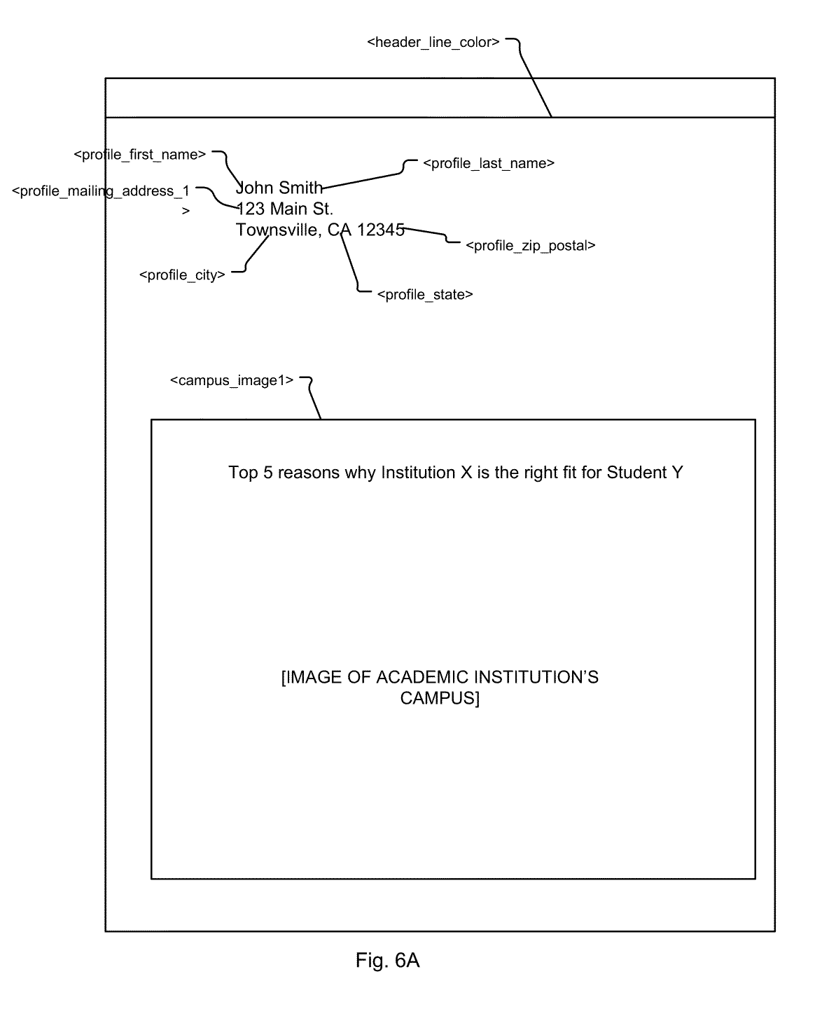

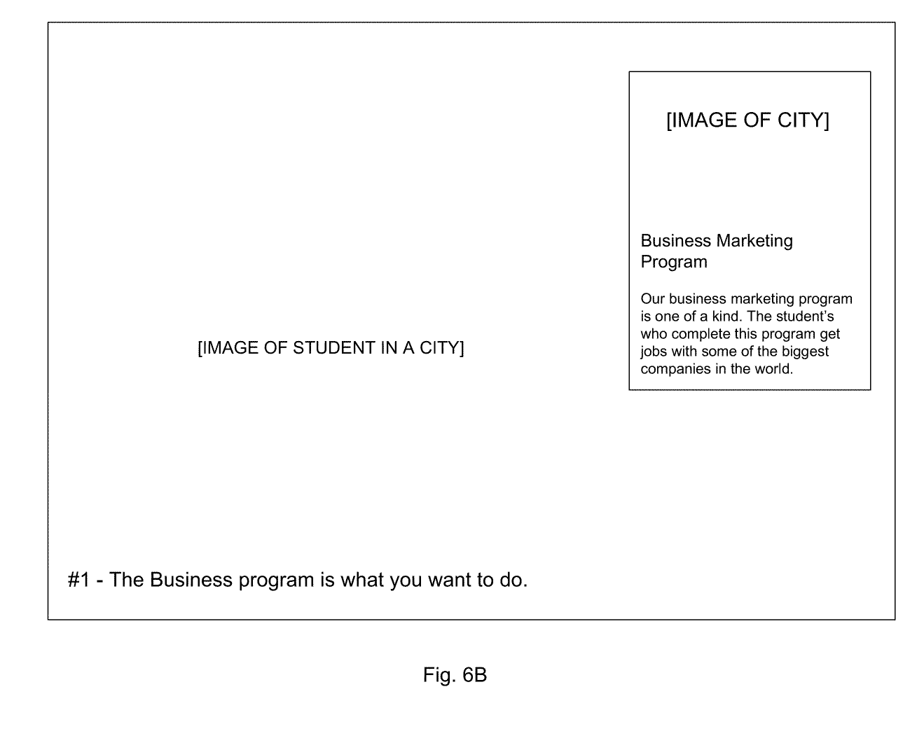

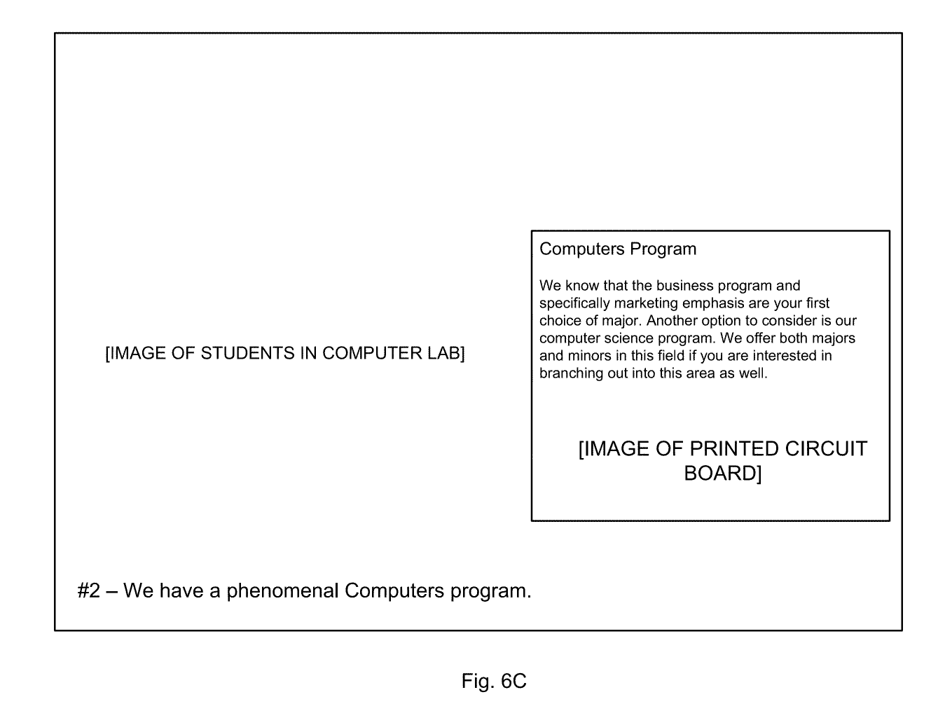

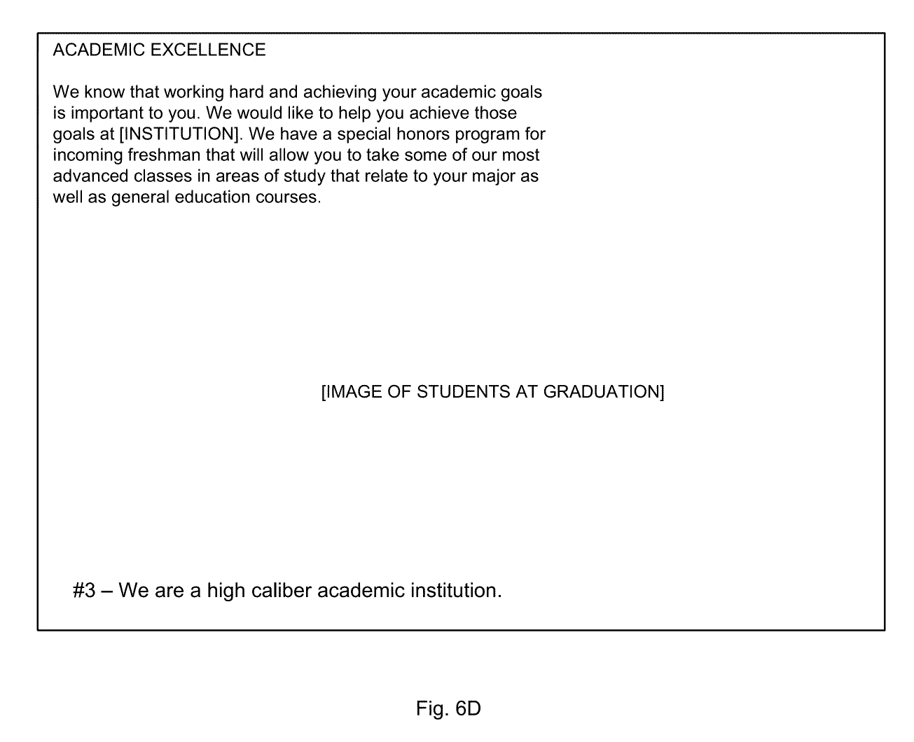

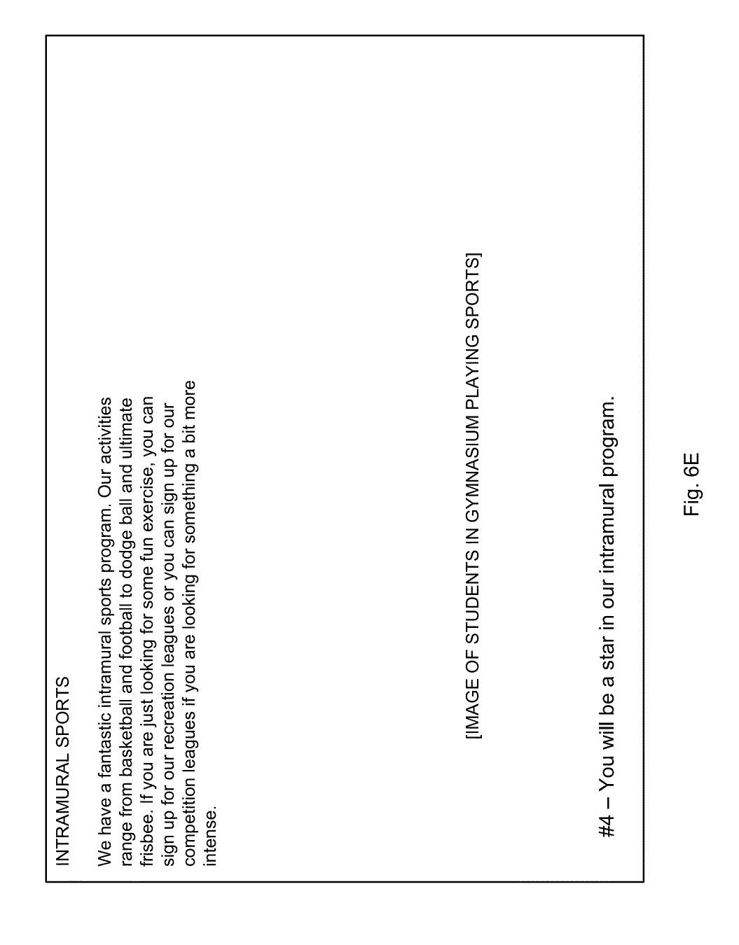

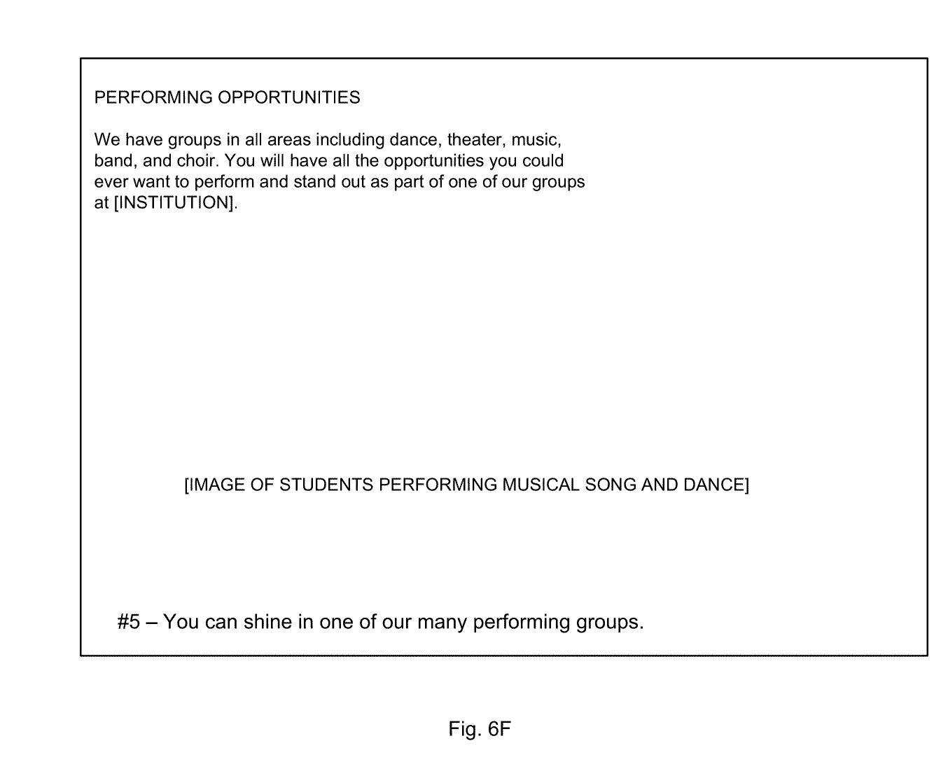

FIG. 6A shows an exemplary cover page of the marketing packet presentation 232 and how the data are included to the marketing packet 232 to create a personalized document for each potential student 244. Each output value corresponds to data entered by a potential student.

In other examples, the marketing packet is displayed as an online or electronic experience as part of the end pages 216 directly after conclusion of the surveys 210, 212, 214.

Table I shows exemplary output values and display details of the information typically displayed on a cover of the marketing packet 232. In one embodiment, the output values are document content tags. Typically, information related to the academic institution (i.e., data not entered by the potential student during the survey) is pulled together using tags for the text & images. The document content data file has content associated with a particular tag along with criteria for when it should be displayed. Thus, when the presentation generator 230 is generating a marketing packet, it needs the documentcontent.txt file, for example, to pull in the appropriate content/branding for that student.

TABLE I

| Cover (Output Value) | Display Details |
|---|---|
| <student_first_name> | Find <student_first_name> in the |
| | StudentPersonal data file |
| <student_last_name> | Find <student_last_name> in the |
| | StudentPersonal data file |
| <campus_image1> | To find the <campus_image1>, use the |
| | <campus_code> from the StudentPersonal |
| | data file to map to the CampusProfiles |
| | data file. Locate <campus_image1>. |

The table shows variables and there source in the files stored in the school specific content database 228 and the output data file 226.

In the example illustrated by Table I, a student interested in a particular campus as stored in the campus_code variable for that student in their StudentPersonal data file is used as a lookup into the CampusProfiles data file so that a campus_image1 picture is inserted into the student's marketing content or packet.

Generally, the background color, style, and overall layout will be the same for all the marketing packets to create some uniformity across all the marketing packets, but because of the customizable nature of the marketing packets it is possible to vary the design of each marketing packet. For example, the academic institution is able to select from different default marketing packet options. The different options vary in size (i.e., number of pages) and which components are will be included with the marketing packet, for example.

FIGS. 6B through 6F show examples of pages of the marketing packet. Alternatively, these pages could be generated as part of the online or electronic experience (e.g., web pages, and app, or as part of an interactive user interface). Specifically, in one example, the marketing packet includes information based on the results of the surveys 210, 212, 214. Thus, for example, FIGS. 6B and 6C display content directed to a business marketing program and a computers program of the academic institution because these areas of academic interest were ranked 1 and 2 in the customized surveys (i.e., the question presented in FIG. 4B). FIGS. 6D through 6F are also based on the results of the surveys 210, 212, 214.

While not illustrated in the figures, the marketing packet 232 typically includes other standard information that is consistent across all marketing packets generated for all of the different students such as what currently enrolled students are saying about their particular experience at the academic institution. Further, the marketing packet 232 might provide recommendations or suggestions of what to do when they first attend the academic institutions such as clubs, orientation meetings, or religious services, which are selected based on the result from the interest surveys 210, 212. Additionally, bibliographic information is also included in the marketing packet such as the student's name, their acceptance status at the academic institution, their declared major (if any), and opportunities for scholarships, for example. Further, their status in the admissions process is also indicated in the marketing material, whether or not they have used the net price calculator 114 that is offered by the institution, and/or whether their application has been received by the academic institution.

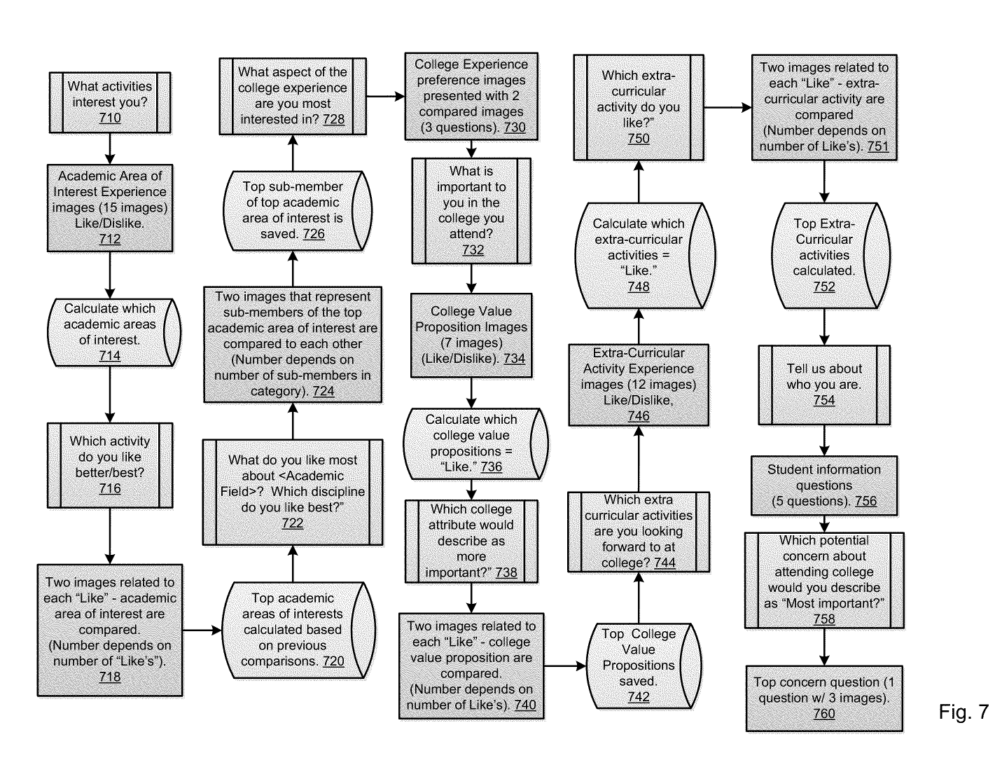

FIG. 7 illustrates more detailed steps associated with the standard interest survey 210 and the customized interest survey 212 shown in FIG. 2, according to one implementation.

In more detail, step 710 represents an introductory question. It asks the candidate: what activities interest you? Then, in step 712, experience images relating to areas of academic interests are displayed to the candidate (e.g., potential student), on their user device allowing the candidate to select “Like/Dislike”. In a current implementation, fifteen images relating to areas of academic interests are presented.

In step 714, an internal calculation is performed by a utility that is executing on the affinity assessment app/Web server 110. Here, it determines the areas of academic interests for the candidate based on the received responses. That is, the calculation is performed based on the images the potential student selected “Like” and/or ranked from most interested to least interested.

Next, the question is displayed in step 716 which asks: which activity do you like better (or best).” The survey proceeds by displaying 2 images related to each area of academic interest for this specific candidate in step 718. In general, the number of image pairs displayed depends on the number of areas of academic interest that the candidate indicated.

Then in step 720, the top academic areas of interest are calculated based on the previous comparisons and the candidate's choices.

In the next step 722, a question is then displayed that asks the candidate: what do you like most about the selected academic field and opens the question as to what discipline the potential student would be most interested in (e.g., “Which discipline do you like better/best?). Next, in step 724, two images that represent sub-members of the top academic area of interest for this candidate are compared to each other. Here again, the number of images that are displayed is dependent upon the sub-members in this category.

In step 726, the top sub-members of the two academic areas of interest are determined and saved.

Next, in step 728, the question is displayed: what aspect of the college experience are you most interested in? The college experience preference images are then displayed in step 730. Three pairs of images are displayed in one example.

Next, in step 732, the question is asked: what is important to you in the college you attend. College value proposition images are then displayed and the candidate is asked to choose “Like/Dislike” in step 734. In step 736, a calculation is performed based on the candidate's response to determine the important college value propositions for this particular candidate.

It is asked in step 738: which college attribute would you describe as more important. Then, in step 740, two images related to each college value proposition are compared. Here again, the number of pairs of images displayed depends on the candidate's specific response (Like's). The top college value propositions for this candidate are determined and saved in step 742 based on the candidate's responses.

In step 744, it is asked: which extracurricular activities are you looking forward to in college. In step 746, the extracurricular activities experience images are displayed. In one example, twelve image pairs are presented. Again, the candidate is asked to select in response to each one “Like/Dislike.”

In step 748, a calculation is performed based on which extracurricular activities are of interest to the candidate. Then, in step 750, further extracurricular activities are displayed. Specifically, in step 751, two images related to each extracurricular activity are compared. Again, the number of image pairs that are displayed are dependent upon the number of extracurricular activities that the candidate was interested in. In step 752, the top extracurricular activities are calculated based on the candidate responses.

In step 754, the question is asked: tell us about who you are. In step 756, student information questions are presented. Then, in step 758, the potential student is asked about potential concerns about attending college. The top concerns are presented as 3 images with one question in step 760. In a typical implementation, the potential student is asked to select which, if any, are concerns. Alternatively, the potential student may be asked to rank the concerns in another embodiment.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method for generating a personalized presentation for marketing an academic institution or institutions to a potential student, the method comprising:
generating a user interface on a user device that enables a potential student to express personal preferences and/or personal information by selecting images displayed on the user device;
the computer system determining personalized marketing content that is relevant to the potential student based on the selected images; and
the computer system generating a presentation customized to the potential student that includes the personalized marketing content.

2. The method according to claim 1, wherein the presentation is transferred to a letter shop to be printed.

3. The method according to claim 2, wherein the letter shop prints and mails the presentation to the potential student.

4. The method according to claim 1, wherein the presentation is presented to the potential student via an electronic experience or accessed via an electronic document downloader.

5. The method according to claim 1, wherein the presentation is emailed to the email address of the potential student.

6. The method according to claim 1, further comprising generating the presentation customized to the potential student using the personal preferences expressed by the potential student to select marketing content that is relevant to the potential student that is stored in a database into a single document.

7. The method according to claim 1, wherein the potential student expresses personal preferences by selecting between two images displayed on the user device.

8. The method according to claim 1, wherein the potential student expresses personal preferences by selecting between multiple images displayed on the user device.

9. The method according to claim 1, wherein the potential student expresses personal preferences by ranking images displayed on the user device.

10. The method according to claim 1, wherein the potential student provides personal information by selecting between images displayed on the user device.

11. The method according to claim 1, wherein the potential student expresses personal preferences by indicating personal preference about a single image displayed on the user device.

12. A computer system for generating a personalized presentation for marketing an academic institution to a potential student, the computer system generating a user interface on a user device that enables a potential student to express personal preferences and/or personal information by selecting images displayed on the user device, determining personalized marketing content that is relevant to the potential student based on the selected images, and generating a presentation customized to the potential student that includes the personalized marketing content.

13. The system according to claim 12, wherein the presentation is transferred to a letter shop to be printed.

14. The system according to claim 12, wherein the letter shop prints and mails the presentation to the potential student.

15. The system according to claim 12, wherein the presentation is presented to the potential student via an electronic experience or accessed via an electronic document downloader.

16. The system according to claim 12, wherein the presentation is emailed to the email address of the potential student.

17. The system according to claim 12, further comprising generating the presentation customized to the potential student using the personal preferences expressed by the potential student to select marketing content that is relevant to the potential student that is stored in a database into a single document.

18. The system according to claim 12, wherein the potential student expresses personal preferences by selecting between two images displayed on the user device.

19. The system according to claim 12, wherein the potential student expresses personal preferences by selecting between two images displayed on the user device.

20. The system according to claim 12, wherein the potential student expresses personal preferences by ranking images displayed on the user device.

21. The system according to claim 12, wherein the potential student provides personal information by selecting between images displayed on the user device.

22. The system according to claim 12, wherein the potential student expresses personal preference by indicating personal preference about a single image displayed on the user device.
